(19) United States
(12) Patent Application Publication
(10) Pub. No.: US 2003/0192226 A1
(43) Pub. Date: Oct. 16, 2003

(54) Animal decoy

(76) Inventor: Tony Cain, Spottsville, KY (US)

Correspondence Address: BOWERS HARRISON LLP, GARY K. PRICE, ESP., 25 RIVERSIDE DRIVE, PO BOX 1287, EVANSVILLE, IN, 47706-1287, US

(21) Appl. No.: 10/412,012

(22) Filed: Apr. 11, 2003

Related U.S. Application Data
(60) Provisional application No. 60/372,644, filed on Apr. 12, 2002.

(51) Int. Cl. A01M 31/06

(52) U.S. Cl. 43/3

(57) ABSTRACT

A process and apparatus for an animal decoy and more particularly pertains to a process for applying a photo-reproduced image to a silhouette decoy is disclosed. The animal decoy includes a body having a two sided flat surface, and a mounting stake for upright usage of the body. The body formed in the shape of a silhouette cut from a flat weather proof and light weight material. At least one side of the body receives a decoy image of a game animal shaped to match the silhouette. The resulting decoy image using the described process herein is a lenticular image, and can best be described as the decoy image coming to life. Slight movement of the body of the decoy will cause the decoy image of the present invention to appear active. Equally important, where the body is stationary, the slightest movement by the game animal viewing the decoy image displayed on the body causes the decoy image to visually alter so that the image appears active. Such effect is unique in the field of art, and effective in creating a more realistically rendered animal decoy to attract game to the hunter.

### CROSS REFERENCES TO RELATED APPLICATIONS

U.S. Provisional Application for Patent No. 60/372,664, filed Apr. 16, 2002, with title, “Animal Decoy” which is hereby incorporated by reference. Applicant claims priority pursuant to 35 U.S.C. Par. 119(e)(I).

Statement as to rights to inventions made under Federally sponsored research and development: Not Applicable

### BACKGROUND OF THE INVENTION

1. Field of the Invention

This invention relates to a process and apparatus for an animal decoy and more particularly pertains to a process for applying a photo-reproduced image to a silhouette decoy.

2. Brief Description of Prior Art

It is well established that silhouette decoys for game animals are effective and desirable alternatives to full-body decoys. The flat silhouettes relevant to the present invention are easily stored, transported and deployed, and often less expensive to produce. Further, flat silhouette decoys can be just as effective for attracting said game birds into the range of hunting instruments as a realistically rendered full-body decoy.

Most game hunters will agree that the more realistic the appearance of an animal decoy the greater the probability that the game will be attracted to the decoy. As a result, decoy development includes two and three dimensional images of a particular game animal printed on a flat silhouette. However, while the prior art silhouettes have improved in representing the animal to be decoyed in a stationary position, the prior art has generally failed in displaying a flat silhouette decoy wherein the animal displayed appears to be active.

Where attempts to create decoy movement have been made, the resulting decoys tend to be difficult to transport and often result in an unrealistic movement that can actually scare game away. For example, some decoys proposed include battery operated motors or lights, others use strings pulled by a hunter or wind driven elements. Many of these prior art decoys are bulky to transport and fragile, often lasting only a single hunting season or less.

As will be seen from the subsequent description, the preferred embodiments of the present invention overcome these and other shortcomings of prior art.

### SUMMARY OF THE INVENTION

The present invention relates to a process and apparatus for an animal decoy and more particularly pertains to a process for applying a photo-reproduced image to a silhouette decoy. The preferred embodiment includes a body having a two sided flat surface, and a mounting stake for upright usage of the body. Said body formed in the shape of a silhouette cut from a flat weather proof and light weight material. At least one side of the body receives a decoy image of a game animal shaped to match the silhouette. The resulting decoy image using the described process herein can best be described as the decoy image coming to life. Slight movement of the body caused by wind, movement in the water, or the like will cause the body to move thereby causing the decoy image of the present invention to appear active. Equally important, where the body is stationary, the slightest movement by the game animal viewing the decoy image displayed on the body causes the decoy image to visually alter so that the image appears active. Such effect is not only unique in the field of art, but effective in creating a more realistically rendered animal decoy to attract game to the hunter.

### BRIEF DESCRIPTION OF THE DRAWINGS

FIG. 1 illustrates a front view of the two components of a preferred embodiment of the present invention, namely, a silhouette form exemplifying the image of a goose, and a mounting stake.

FIG. 2 illustrates a front view of the decoy image of FIG. 1.

FIG. 3 illustrates an exploded perspective view of the mounting stake of FIG. 1.

FIG. 4 illustrates a first view of the assembled components of FIG. 3.

FIG. 5 illustrates a second view of the assembled components of FIG. 3.

FIG. 6 illustrates a side view of the assembled components of FIG. 3.

### DESCRIPTION OF THE PREFERRED EMBODIMENT

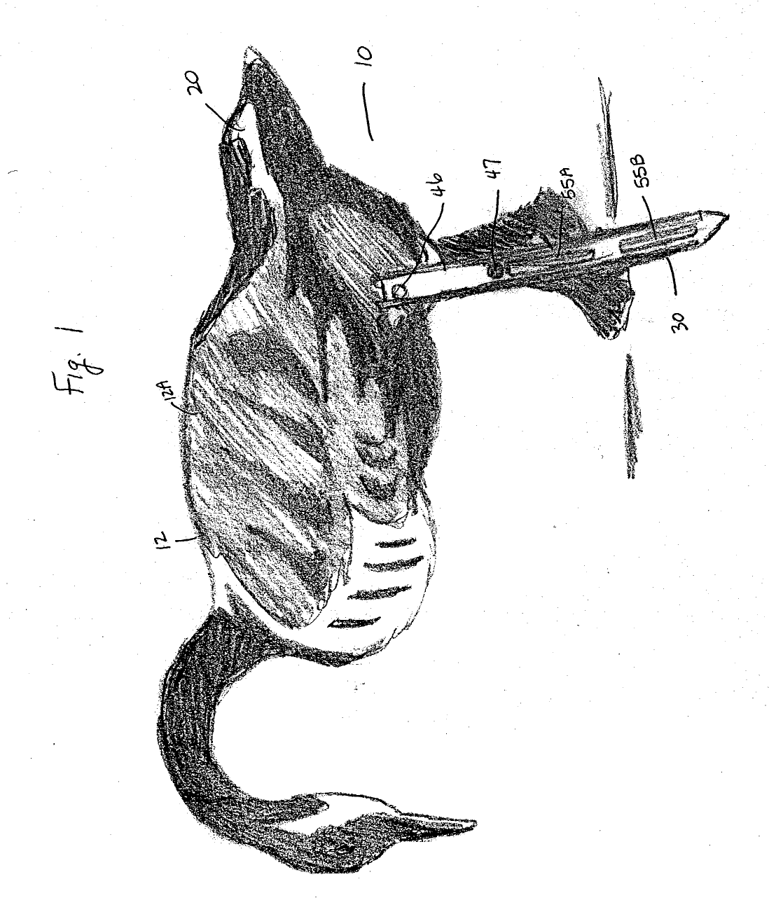

FIGS. 1-6 illustrate a preferred embodiment of an animal decoy device 10 made in accordance with the present invention. Said device 10 having a decoy image 20 printed thereon. While the decoy image 20 as described herein is the image of a goose, it is understood that the image may be of any other game animal.

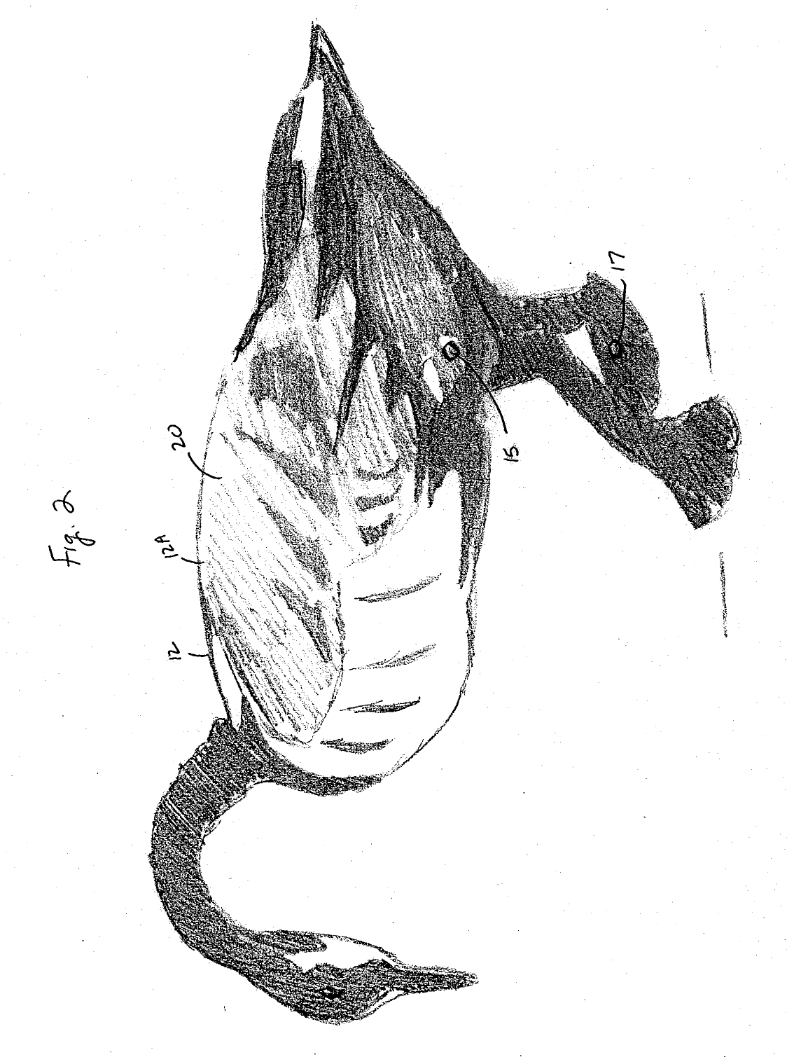

The device 10 includes a body 12 preferably formed in the shape of a silhouette cut from a flat weather proof and light weight material, and a mounting stake 30. The body 12 receives the decoy image 20 shaped to match the silhouette. As stated the body 12 is preferably formed from a two sided flat sheet, said body 12 having a first sided flat surface 12A and a second sided flat surface 12B (not shown). As best shown in FIG. 2, the body 12 includes a first slot opening 15 disposed in the approximate lower midway of the body 12 and a second slot opening 17 disposed below the first slot opening 15. Said first slot opening 15 and said second slot opening 17 on the same axis as the mounting stake 30.

In general, the decoy image 20 is received on the first sided flat surface 12A of the body 12 in a manner further described herein; and the decoy image 20 is received on the second sided flat surface 12B in a similar manner. As should be appreciated from the description herein, the device 10 is symmetrically constructed with said pair of surfaces 12A and 12B on opposite sides of the body 12. As such, while only the first sided flat surface 12A found on one side of the body 12 is shown in FIG. 1, it should be understood that the decoy image 20 received on the second sided flat surface 12B is preferably identical to the decoy image 20 received on the first sided flat surface 12A as described, with the exception that the second sided flat surface 12B is a mirror image of the first sided flat surface 12A described. Alternatively, the body 12 may be formed from first and second flat sheets of material (not shown) where the decoy image 20 is received on one side of the first flat sheet and on one side of the second flat sheet. Said first and second flat sheets are then attached so that the decoy image 20 is displayed on opposite sides of the formed body. Specifically, the decoy image 20 displayed on the one side of the first flat sheet, is a mirror image of the decoy image displayed on the opposite side.

The process for preparing the decoy image 20 for display on the surface of the body 12 is called lenticular photography, and the resulting decoy image 20 is a lenticular image.

To receive the decoy image 20 on the first sided flat surface 12A of the body 12, a printed flat image of two or more images of the game animal are interlaced in narrow strips. Interlacing allows two or images to display using the same surface area. Each image is referred to in the trade as a flip image. Flip images are any two images that flip back and forth as you turn the image. For example, the head and neck of the goose may flip from a first imaged position to a second imaged position and back to the first position. Said flip image is converted to a three-dimensional image. Preferably, such conversion from a flip image to a three-dimensional image is performed digitally or other means known in the art. The three-dimensional flip image can be printed on a durable outdoor photographic material such as Kodak's Duratrans which finds application in outdoor signage because of its durability. The image is then printed on the flat surface 12A of the body 12 having a sheet of plastic as an upper layer, said sheet of plastic having a series of cylindrical lenses molded in parallel rib-like rows. Each of said cylindrical lens magnifies a very narrow strip of the said image. As a result, as the viewer changes the angle of view the strip of image being magnified also changes. Obviously, the same process is used when printing the art on the second sided flat surface 12B of the body 12. Said surfaces 12A and 12B are coated with a suitable coating substance known in the art to impart a low reflectivity to the image. The resulting decoy image 20 using the above process can best be described as the decoy image 20 being animated. Slight movement of the body 12 caused by wind, movement in the water, or the like will cause the body 12 to move thereby causing the decoy image 12 to appear active. Equally important, where the body 12 is stationary, the slightest movement by the game animal viewing the decoy image 12 displayed on the body 12 causes the decoy image 12 to visually alter so that the image 12 appears active. Such effect is not only unique in the field of art, but effective in creating a more realistically rendered decoy to attract game to the hunter.

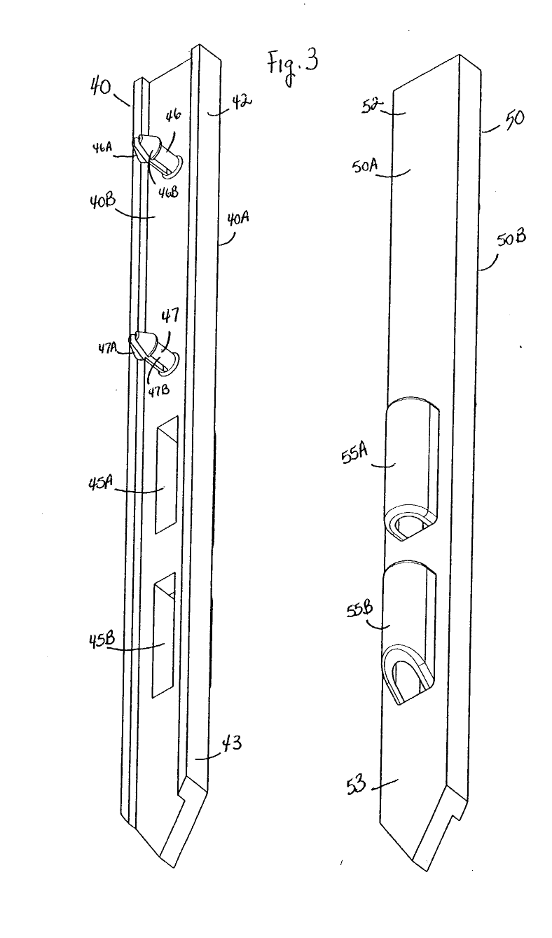

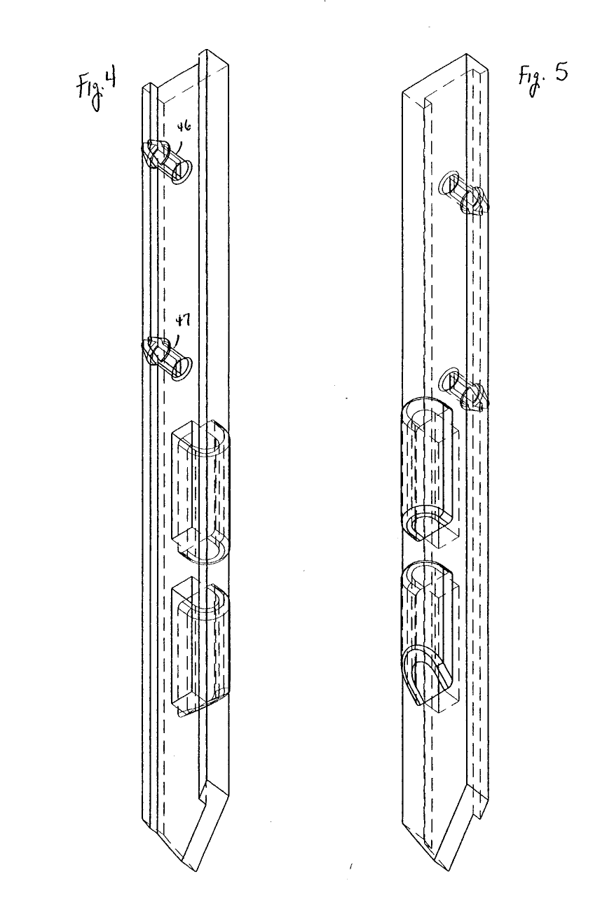

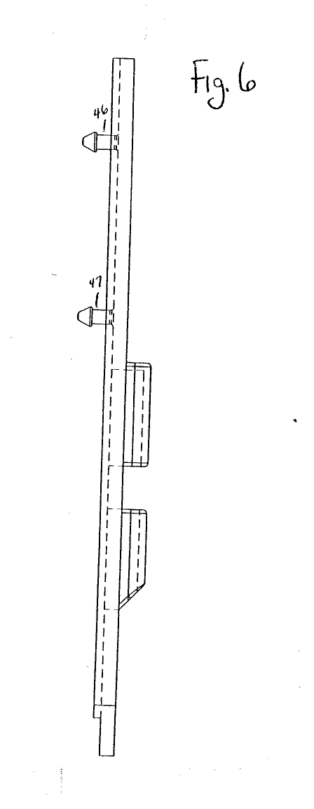

The device 10 further includes said mounting stake 30 for upright usage of the body 12. As best shown in FIG. 3, said mounting stake 30 including a first member 40 and a second member 50. As shown in FIGS. 4-5, attaching said first and second members 40, 50 forming said mounting stake 30.

Referring again to FIG. 3, said second member 50 having a front side 50A and a back side 50B, said second member 50 further including an upper end 52 and a lower end 53, and a pair of linkage members 55A and 55B disposed on the approximate lower end 53 of the front side 50A of the second member 50.

Said first member 40 having a front side 40A and a back side 40B, said first member 40 further including an upper end 42 and a lower end 43, a pair of apertures 45A and 45B disposed on the approximate lower end 43 of the first member 40. Said apertures 45A and 45B extend through the first member 40 from the front side 40A to the back side 40B, and said apertures 45A and 45B sized and positioned to receive said linkage members 55A and 55B of the second member 50.

The first member 40 attaches to the second member 50 forming the mounting stake 30 by placing the front side 40A of the first member 40 and the front side 50A of the second member 50 in abutting relationship so that the linkage members 55A and 55B of the second member 50 passes through the apertures 45A and 45B of the first member 40, as shown in FIGS. 4-6.

The device 10 further including attaching means for mounting the mounting stake 30 to the body 12. In the preferred embodiment said attaching means including a first clip 46 disposed on the upper end 42 of the back side 40B of the first member 40 and a second clip 47 disposed below the first clip 46. Said first and second clips 46 and 47 on the same axis as the apertures 45A and 45B.

The first slot opening 15 of the body 12 sized and positioned to receive the first clip 46 of the first member 40, and the second slot opening 17 sized and positioned to receive the second clip 47 of the first member 40. Inserting the first clip 46 in the first slot opening 15, and inserting the second clip 47 in the second slot opening 17 effectively attaches the body 12 to the mounting stake 30.

As best shown in FIG. 3, said first and second clips 46 and 47 each having a first half portion 46A, 47A and second half portion 46B, 46B, respectively. Inserting the first clip 46 into the first slot opening 15 causes the portions 46A and 46B to compress and pass through the opening 15. Once the upper portion of the clip 46 passes through the opening 15, the portions 46A and 46B will again separate to its original position as shown in FIG. 3, thereby detachably locking the clip 46 to the body 12. Obviously, the attachment and locking of the second clip 47 to the second slot opening 47 is identical to the first clip 46 as described above.

In use the decoy 10 is flat, several can easily be stacked together for transport to a hunting site. Also, the resulting decoy is tough and will be long lasting because it has no actual moving parts to be mashed, tangled or broken in transit.

Although the description above contains many specificities, these should not be construed as limiting the scope of the invention but as merely providing illustrations of a presently preferred embodiment of this invention.

Thus the scope of the invention should be determined by the appended claims in the formal application and their legal equivalents, rather than by the examples given.

I claim:

1. An animal decoy comprising:
a body having a first side flat surface and a second side flat surface, a first slot opening disposed in the approximate lower midway of the body, and a second slot opening disposed below the first slot opening on the same axis;
a mounting stake having a first clip and a second clip, and
a decoy image received on the first side flat surface and the second side flat surface.

2. An animal decoy as recited in claim 1, wherein the decoy image is a lenticular image.

3. An animal decoy comprising:
a body having a first side flat surface and a second side flat surface, a mounting stake mounting said body,
a decoy image on said body,
a first lenticular panel covering said decoy image to create an illusion of movement of said decoy image on said body.

4. The animal decoy as recited in claim 3, wherein said decoy image is transparent and sandwiched between said first lenticular panel and a second lenticular panel.

5. The animal decoy as recited in claim 3, wherein said body has an outline cut to form a silhouette of a game animal.

6. The animal decoy as recited in claim 5, wherein said decoy image is created from at least a portion of an actual photograph of a game animal.

7. The animal decoy as recited in claim 6, wherein said first lenticular panel includes a mat surface to reduce glare.

8. The animal decoy as recited in claim 5, wherein the mounting is flexible to allow movement of the body in wind or water.

9. The animal decoy as recited in claim 5, wherein said mounting includes a sharpened stake clipped to the body.

10. The animal decoy as recited in claim 5, wherein said lenticular panel includes a plurality of semi-cylindrical lenses molded in parallel rows on said panel.

11. The animal decoy as recited in claim 10, wherein said image includes strip portions of two different images.

12. An animal decoy comprising:
a body having a first side surface and a second side surface, a mounting supporting said body,
a first decoy image on said body,
a first lenticular panel covering said first decoy image to create an illusion of movement of said decoy image on said body.

13. The animal decoy as recited in claim 12, wherein said first decoy image is printed on said first side surface and wherein a second decoy image is printed on said second side surface and wherein a second lenticular panel covers said second image.

14. The animal decoy as recited in claim 13, wherein said body has an outline cut to form a silhouette of a game bird.

15. The animal decoy as recited in claim 14, wherein said first and second lenticular panels includes mat finish to reduce glare.

16. The animal decoy as recited in claim 15, wherein the mounting is flexible to allow movement of the body.

17. The animal decoy as recited in claim 16, wherein said lenticular panels includes a plurality of semi-cylindrical lenses molded in parallel rows on said panels.

18. The animal decoy as recited in claim 10, wherein said first and second decoy images each include strip portions of two different photographs.
